(19) United States
(12) Patent Application Publication
(10) Pub. No.: US 2016/0268613 A1
(43) Pub. Date: Sep. 15, 2016

(54) FUEL CELL SYSTEM FOR INDUSTRIAL ELECTRIC VEHICLE

(71) Applicant: M-field Energy LTD., Taipei City (TW)

(72) Inventors: CHE-PING CHOU, Taipei (TW); CHEN-SHENG LIN, Taipei (TW); CHIH-PIN HSU, Taipei (TW)

(21) Appl. No.: 14/641,680

(22) Filed: Mar. 9, 2015

(51) Int. Cl. H01M 8/04

(52) U.S. Cl. CPC H01M 8/04074; H01M 8/04126; H01M 2250/20

(57) ABSTRACT

A fuel cell system for a forklift includes a fuel cell stack consisting of an anode, a cathode and a coolant passage. A fuel tank is provided for supplying hydrogen to the anode. An air blower is provided for supplying air to the cathode. A pump is used for circulating coolant through the coolant passage. A heat exchanger is positioned at downstream of the fuel tank and the pump and in fluid coupling therewith. The hydrogen absorbs heat from the coolant in the heat exchanger before the hydrogen flows to the anode. The air absorbs heat from the coolant in a radiator before the air flows to the cathode. The radiator is in fluid coupling with the heat exchanger and the coolant passage and located therebetween.

### CROSS-REFERENCE TO RELATED APPLICATIONS

This application is related to co-pending patent application number ______, entitled “HYBRID ELECTRICAL POWER SYSTEM FOR INDUSTRIAL ELECTRIC VEHICLE” and having an attorney docket number “US57957”, and co-pending application number ______, entitled “HYBRID ELECTRICAL POWER SYSTEM FOR INDUSTRIAL ELECTRIC VEHICLE AND METHOD OF OPERATION THEREOF” and having an attorney docket number “US57958.” The two co-pending applications are assigned to the same assignee as the present application and have the same filing date as the present application. The disclosures of the two co-pending applications are incorporated herein by reference.

### FIELD

The subject matter herein generally relates to a fuel cell system, and particularly to a fuel cell system for use in an industrial electric vehicle such as an electric forklift which can preheat the fuel and the oxidant thereof before they are reacted to generate electricity.

### BACKGROUND

Industrial vehicles such as forklifts may be used in a sub-zero temperature environment to handle frozen goods in a warehouse. When the industrial vehicles which are powered by fuel cells used in the sub-zero temperature environment, problems occur since reactants of the fuel cells need to be at a raised temperature in order to have complete chemical reaction therebetween to effectively generate electricity.

U.S. Pat. No. 8,771,884 B1 to Cacioppo et al. discloses a fuel cell system which preheats fuel by a heat exchange between the fuel and oxidant to prevent formation of liquid water in the fuel before the fuel is fed into the fuel cell.

US Patent Application Publication No. 2011/0070508 A1 to Tanaka et al. discloses a fuel cell system which has a heat exchanger fan for generating an airflow. The airflow flows through a heat exchanger and guided by a guide to blow and diffuse anode purge gas discharged from an exhaust pipe.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present fuel cell system. Moreover, in the drawings, like reference numerals designate corresponding parts throughout the several views.

FIG. 1 is an exploded view of a fuel cell system according to an embodiment of the present disclosure.

FIG. 2 is an assembled, isometric view of a hybrid electrical power device having the fuel cell system of FIG. 1.

FIG. 3 is a diagrammatic side view of the hybrid electrical device of FIG. 2, with some parts thereof removed to show a detail of an inner structure of the fuel cell system.

FIG. 4 is an enlarged isomeric view of a heat exchanger of the fuel cell system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

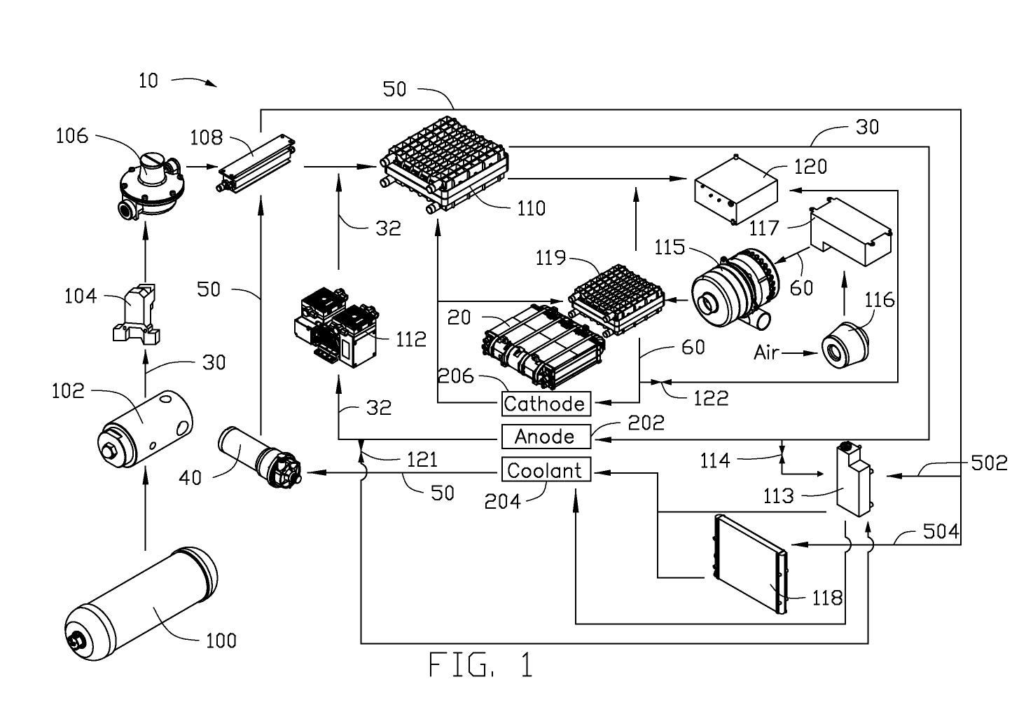

Referring to FIG. 1, a fuel cell system 10 in accordance with the present disclosure is for use in an industrial electric vehicle for example a forklift to provide power required for driving the vehicle to work as intended. The fuel cell system 10 includes a fuel tank (preferably a hydrogen tank) 100 which is in fluid coupling with an anode 202 of a fuel cell stack 20 via a fuel pipeline 30. The fuel tank 100 is substantially cylindrical in shape. The fuel pipeline 30 couples the fuel tank 100 with the anode 202 in series via a high pressure regulator 102, a solenoid valve 104, a low pressure regulator 106, a heat exchanger 108 and a first humidifier 110, whereby fuel in the fuel tank 100 can flow to the anode 202 with a predetermined flow rate and level of humidity to have an optimal chemical reaction therein. The first humidifier 110 increases the humidity of the fuel before it enters the anode 202. After the chemical reaction, the fuel is pumped by a fuel pump 112 to reenter the fuel pipeline 30 at a location between the heat exchanger 108 and the first humidifier 110 via an auxiliary fuel pipeline 32. Water in the fuel before it enters the anode 202 is drained to an auxiliary water tank 113 via a first valve 114. Water in the fuel after it leaves the anode 202 is drained to the auxiliary water tank 113 via a second valve 121.

A coolant pump 40 is in fluid coupling between the heat exchanger 108 and a coolant (preferably water) passage 204 of the fuel cell stack 20 via a coolant pipeline 50; the heat exchanger 108 in turn is in fluid coupling with the auxiliary water tank 113 and a radiator 118 in parallel via two branches 502, 504 of the coolant pipeline 50. Outlets of the auxiliary water tank 113 and the radiator 118 are in fluid coupling with the coolant passage 204 of the fuel cell stack 20 in parallel. By a driving of the coolant pump 40, coolant can circulate through the heat exchanger 108, the auxiliary water tank 113, the radiator 118 and the coolant passage 204 to take heat away from the fuel cell stack 20 which is generated by the chemical reaction between the fuel in the anode 202 and the oxidant in a cathode 206 of the fuel cell stack 20. The chemical reaction between the fuel and the oxidant can generate electricity. The radiator 118 is provided for releasing the heat of the coolant to atmosphere thereby to lower the temperature of the coolant before it enters the coolant passage 204 of the fuel cell stack 20.

The oxidant to react with the fuel is obtained from air in the atmosphere. The air is drawn into the cathode 206 of the fuel cell stack 20 by an air blower 115. The air flows from a filter 116, a resonator 117, the air blower 115 and a second humidifier 119 to reach the cathode 206 of the fuel cell stack 20 via an air pipeline 60. The second humidifier 119 is provided to increase the humidity of the air before it enters the cathode 206. The resonator 117 is provided for lowering noise level produced by the air blower 117 in drawing the air into the cathode 206. Water in the air before it enters the cathode 206 is drained to an exhaust water tank 120 via a third valve 122. Exhaust air from the cathode 206 flows to the first and second humidifiers 110, 119 which are in fluid communication with the exhaust water tank 120.

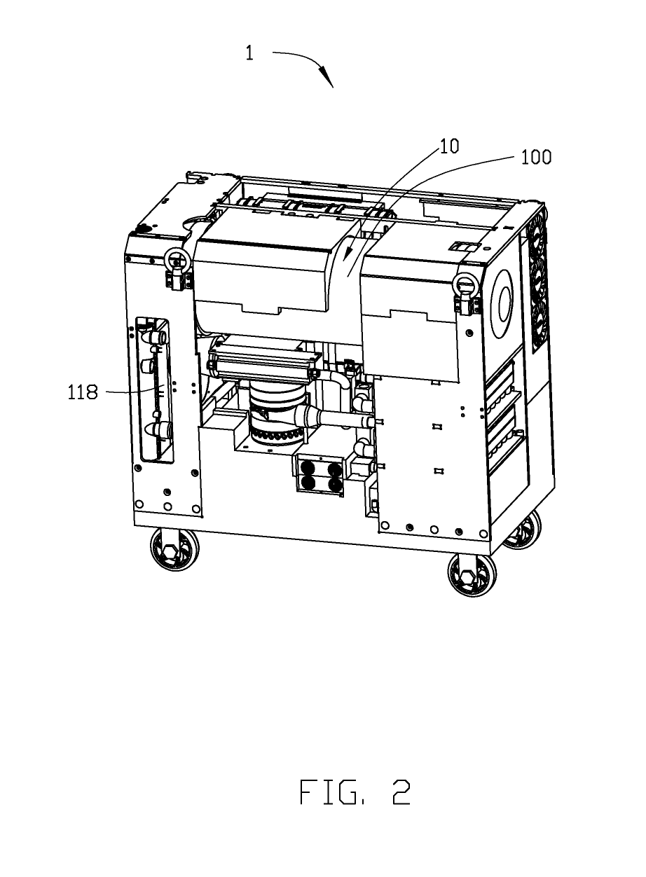

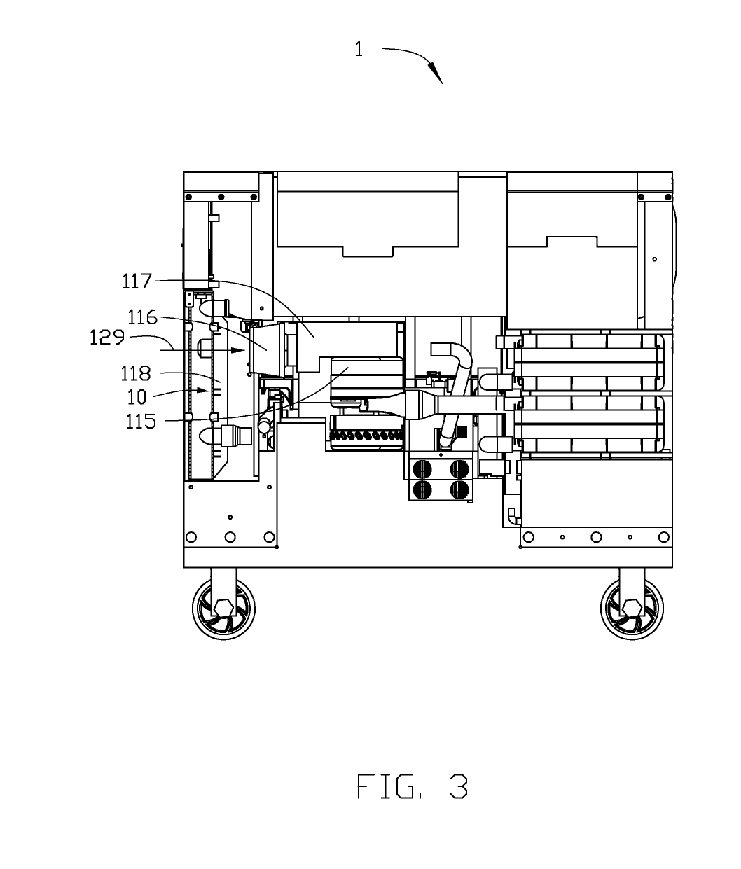

Now referring to FIGS. 2 and 3, a hybrid electrical power device 1 including the fuel cell system 10 in show. In assembly the fuel tank 100 is located at a top of the system 10 of the device 1 and the filter 116, the resonator 117 and the air blower 115 are located under the fuel tank 100. The radiator 118 is located in front of the filter 116, whereby when the air blower 115 operates air flows, as indicated by an arrow 129 in FIG. 3, through the radiator 118 to enter the filter 116 and then the resonator 117, the air blower 115 and the second humidifier 119 to reach the cathode 206 of the fuel cell stack 20. Since the radiator 118 releases heat from the coolant, the air flowing through the radiator 118 can be heated by it whereby the oxidant in the air in the cathode 206 can have a raised temperature to have an optimal chemical reaction with the fuel in the anode 202 to generate electricity efficiently.

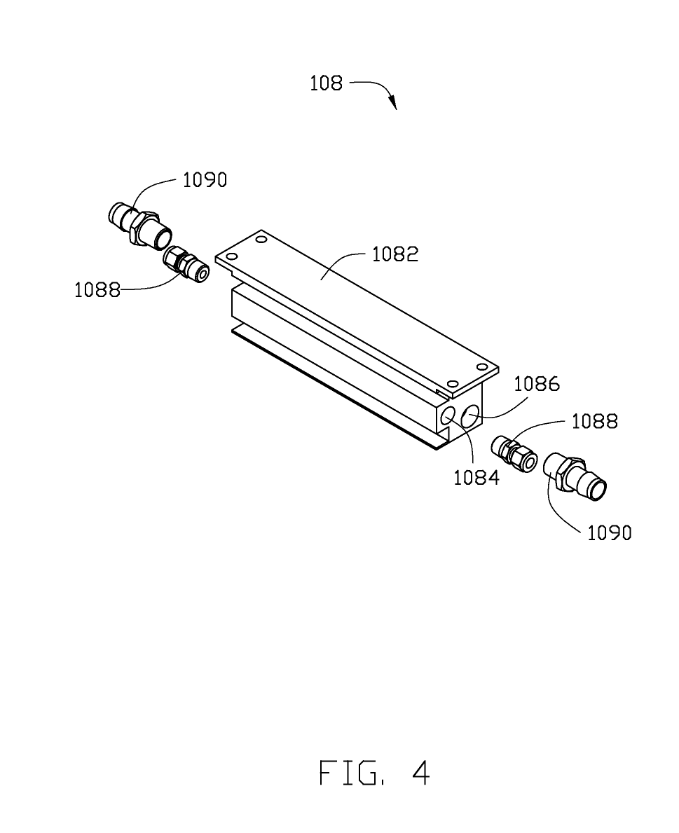

Referring to FIG. 4 the heat exchanger 108 is formed by a metal block 1082, which preferably is a copper block and defines two conduits 1084, 1086 therethrough along a lengthwise direction thereof. A pair of first adaptors 1088 is secured to two opposite ends of the conduit 1084 for fluidically coupling the conduit 1084 with the coolant pipeline 50 coupling with the coolant pump 40 and the coolant pipeline 50 coupling with the auxiliary water tank 113 and the radiator 118. A pair of second adaptors 1090 is secured to two opposite ends of the conduit 1086 for fluidically coupling the conduit 1086 with the fuel pipeline 30 coupling with the fuel tank 100 and the fuel pipeline 30 coupling with the first humidifier 110. By the heat exchanger 108 the fuel can be heated by the coolant before the fuel enters the anode 202 of the fuel cell stack 20 via the first humidifier 110 whereby the fuel in the anode 202 can have a raised temperature in chemical reaction with the oxidant in the cathode 206 to generate electricity efficiently

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A fuel cell system for an industrial electric vehicle comprising:
a fuel cell stack having an anode, a cathode and a coolant passage;
a fuel tank;
a heat exchanger having a first fluid flow-through passage and a second fluid flow-through passage so as to allow transfer of heat from the first fluid to the second fluid, the first fluid flow-through passage being in fluid communication with the fuel tank and the fuel cell stack anode;
an air blower for drawing air into the fuel cell stack cathode; and
a pump in fluid communication with the second fluid flow-through passage of the heat exchanger and the fuel cell stack coolant passage;
wherein, the pump drives coolant to flow into the fuel cell stack coolant passage and through the second fluid flow-through passage of the heat exchanger, and fuel flows from the fuel tank through the first fluid flow-through passage of heat exchanger absorbing heat from the coolant before flowing to the fuel cell stack anode.

2. The fuel cell system of claim 1 further comprising a radiator for releasing the heat of the coolant to atmosphere, and wherein the air is drawn into the cathode after the air flows through the radiator to absorb the heat released by the radiator.

3. The fuel cell system of claim 2, wherein the heat exchanger is made of a metal block defining two conduits therethrough, one of the conduits being provided for forming the first fluid flow-through passage for flow of the fuel therethrough and the other of the conduits being provided for forming the second fluid flow-through passage for flow of the coolant therethrough.

4. The fuel cell system of claim 2 further comprising a first humidifier in fluid communication with the heat exchanger and the anode and located between the heat exchanger and the anode in respect to a flowing direction of the fuel.

5. The fuel cell system of claim 4 further comprising a fuel pump in fluid communication with the anode and the first humidifier for recycling the fuel from the anode to the first humidifier.

6. The fuel cell system of claim 5 further comprising a high pressure regulator, a solenoid valve and a low pressure regulator between the fuel tank and the heat exchanger.

7. The fuel cell system of claim 2 further comprising a second humidifier in communication with the cathode and the air blower and located between the air blower and the cathode in respect to a flowing direction of the air.

8. The fuel cell system of claim 7 further comprising a filter and a resonator in fluid communication with the air blower, the filter being located between the resonator and the radiator and the resonator being located between the filter and the air blower in respect to a flowing direction of the air, the resonator being configured for lowering level of noise when the air blower is operated to draw the air into the cathode.

9. The fuel cell system of claim 2 further comprising an auxiliary coolant tank for collecting water from the fuel before it enters the anode and after it leaves the anode, the auxiliary coolant tank being in fluid communication with the coolant passage and the heat exchanger and located between the heat exchanger and the coolant passage in respect to a flow direction of the coolant.

10. The fuel cell system of claim 9, wherein the heat exchanger is in fluid communication with the auxiliary coolant tank and the radiator in parallel.

11. A fuel cell system comprising:
a fuel cell stack comprising an anode, a cathode and a coolant passage;
a fuel supplier comprising:
a fuel tank; and
a heat exchanger in fluid communication with the fuel tank and the anode of the fuel cell stack;
an oxidant supplier comprising:
an air blower for drawing air into the cathode of the fuel cell stack; and
a coolant supplier comprising:
a pump in fluid communication with the heat exchanger and the coolant passage of the fuel cell stack; and
a radiator in fluid communication with the heat exchanger and the coolant passage;
wherein in operation of the fuel cell system, coolant flows from the coolant passage to the heat exchanger by a driving of the pump, fuel flows from fuel tank to the heat exchanger and absorbs heat of the coolant in the heat exchanger before the fuel flows from the heat exchanger to the anode to have a chemical reaction with oxidant in the air in the cathode, and the air is drawn by the air blower to flow to the cathode after the air flows through the radiator to absorb heat of the coolant in the radiator.

12. The fuel cell system of claim 11, wherein the fuel supplier further comprises a first humidifier, the fuel flows to the first humidifier after the fuel leaves the heat exchanger.

13. The fuel cell system of claim 11, wherein the oxidant supplier further comprises a second humidifier located between the air blower and the cathode, whereby humidity of the air is increased before the air enters the cathode.

14. The fuel cell system of claim 13, wherein the oxidant supplier further comprises a filter and a resonator located between the radiator and the air blower, the resonator being configured for lowering level of noise when the air blower is operated to draw the air into the cathode.

15. A fuel cell system for use in an industrial electric vehicle comprising:
a fuel cell stack comprising an anode, a cathode and a coolant passage;
a fuel supplier comprising:
a hydrogen tank in fluid communication with the anode of the fuel cell stack;
an oxidant supplier comprising:
an air blower for drawing air into the cathode of the fuel cell stack; and
a coolant supplier comprising:
a pump in fluid communication with the coolant passage of the fuel cell stack; and
a radiator in fluid communication with the pump and the coolant passage;
wherein in operation of the fuel cell system, coolant flows from the coolant passage to the radiator by a driving of the pump, hydrogen in the hydrogen tank flows from the hydrogen tank to the anode to have a chemical reaction with oxidant in the air in the cathode, and the air is drawn by the air blower to flow to the cathode after the air flows through the radiator to absorb heat of the coolant in the radiator.

16. The fuel cell system of claim 15, further comprising a heat exchanger in fluid communication with the hydrogen tank and the pump, wherein the hydrogen in the hydrogen tank flows to the anode via the heat exchanger, the coolant flows to the radiator via the heat exchanger, and the hydrogen in the heat exchanger absorbs heat of the coolant in the heat exchanger.

17. The fuel cell system of claim 16, further comprising an auxiliary tank, the heat exchanger being in fluid coupling with the auxiliary tank and the radiator in parallel.

18. The fuel cell system of claim 16, wherein the fuel supplier further comprises a first humidifier for humidifying the hydrogen after the hydrogen absorbs heat of the coolant in the heat exchanger.

19. The fuel cell system of claim 16, wherein the oxidant supplier further comprises a second humidifier for humidifying the air before the air is drawn by the air blower into the cathode.

20. The fuel cell system of claim 19, wherein the oxidant supplier further comprises a filter and a resonator, the air drawn by the air blower flows through the radiator to enters the filter and then flows from the filter to the cathode via the resonator, the air blower and the second humidifier, the resonator being configured for lower noise level when the air blower draws the air into the cathode.
